(19) United States
(12) Patent Application Publication
(10) Pub. No.: US 2007/0182655 A1
(43) Pub. Date: Aug. 9, 2007

(54) Broad-band log-periodic dipole antenna

(75) Inventors: Han-Lim Lee, Seoul (KR); Seong-Taek Hwang, Pyeongtaek-si (KR); Sung-Hun Kim, Sacheon-si (KR); Young-Sik Kim, Seoul (KR); Ji-Chai Jeong, Seoul (KR); Jung-Woo Baik, Seoul (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/601,422

(22) Filed: Nov. 17, 2006

(30) Foreign Application Priority Data
Feb. 7, 2006 (KR) 11670/2006

(51) Int. Cl. H01Q 11/10

(52) U.S. Cl. 343/792.5

(57) ABSTRACT

Disclosed is a broadband log-periodic dipole antenna, which has first and second radiating elements alternately and symmetrically arranged in both surfaces of a dielectric substrate according to the corresponding PCS frequency band, IMT-2000 frequency band, and wireless LAN (IEEE 802, 11a/b) frequency band, so that the first and second radiating elements are alternately supplied with signals to make the impedance matching, thereby producing high gain in each of the resonant frequency bands and preventing the distortion of the radiating patterns owing to the broadband characteristics. The arrangement of the first and second radiating elements in both surfaces of the dielectric substrate considerably also reduces the size of the antenna, thereby facilitating mass production with low cost.

### CLAIM OF PRIORITY

This application claims priority under 35 U.S.C. §119 to an application entitled “Broad-Band Log-Periodic Dipole Antenna,” filed in the Korean Intellectual Property Office on Feb. 7, 2006 and assigned Serial No. 2006-11670, the entire contents of which are hereby incorporated herein by reference.

### BACKGROUND OF THE INVENTION

1. Field of the Invention

The present invention relates to a broad-band log-periodic antenna for serving a broad frequency band of 1.8 GHz to 6 GHz in a wireless communications system.

2. Description of the Related Art

As the recent development of the wireless communications system demands high-speed transmission of huge data, higher frequency bands are used for frequency distribution in order to mitigate saturation of the low frequency bands. In particular, the frequency band of 1.8 GHz to 6 GHz essentially serves for IMT-2000, wireless LAN, ISM, mobile Internet, and therefore an antenna is required which may serve such broadband. There have been proposed various antennae such as wire antenna, helical antenna, bi-conical antenna, sleeve antenna, loop antenna, log-periodic antenna, and YAGI-UDA antenna.

Among these various antennae, the log-periodic antenna is a type that periodically repeats the impedance and radiating characteristics for the frequency and is regarded as a frequency-independent antenna owing to insignificant variation of the characteristics over the frequency band. A log-periodic antenna has been developed having various forms including sawtooth wedge, sawtooth trapezoid, trapezoidal wire, trapezoidal wedge-type wire, and zigzag wire.

FIG. 1A illustrates the structure and design parameters of a conventional single log-periodic dipole antenna, comprising N dipole elements 3-1 to 3-8 vertically arranged with a constant interval according to both log-periodic ratio τ and scaling constant σ and designed so as to become longer going from left to right. The dipole elements receive the signals fed from the power feeding point 1 on the top through the parallel transmission line (boom) 5. Referring to FIG. 1A, reference symbol aₖ represents the radius of each of the dipole elements 3-1 to 3-8, Lₖ the length of each of the dipole elements 3-1 to 3-8, dₖ the interval between two adjacent dipole elements 3-1 to 3-8, and Y_{T} the terminal admittance. The structural constants imparting the log-periodic characteristics include the log-periodic ratio determining the lengths of the dipole elements 3-1 to 3-8 and the scaling constant σ determining the interval, as defined in the following Formulae 1 and 2:

$$\begin{matrix}τ = \frac{{L}_{k + 1}}{{L}_{k}} = \frac{{a}_{k + 1}}{{a}_{k}} \frac{{R}_{k + 1}}{{R}_{k}} = \frac{{d}_{k + 1}}{{d}_{k}} \\ wherein k = 1 , 2 , 3 … n - 1. & Formula 1 \\ σ = \frac{{d}_{k}}{2 {L}_{k}} = \frac{1}{4} ( 1 - τ ) cot a & Formula 2\end{matrix}$$

wherein, reference symbol Rₖ represents the distance from the top of the log-periodic dipole antenna to the “k^{th}” dipole element, and aₖ the half-flare angle of the log-periodic dipole antenna. The most important advantage of the log-periodic dipole antenna is the broadband characteristics that are also utilized for making a conventional double band log-periodic dipole antenna.

FIG. 1B illustrates the structure of the conventional double band log-periodic dipole antenna that comprises a first log-periodic dipole antenna 10 with a first waveguide 12 and first dipole elements 14 to serve for the IMT-2000 frequency band, and a second log-periodic dipole antenna 20 with a second waveguide 22, second dipole elements 24 and a reflector 26 arranged coaxially with the first log-periodic dipole antenna 10. This double band log-periodic dipole antenna works in the two frequency bands in that if the first log-periodic dipole antenna 10 is supplied with signals, the second log-periodic dipole antenna 20 serves as a reflector, and if the second log-periodic dipole antenna 20 is supplied with signals, the first log-periodic dipole antenna 10 serves like the waveguides 12 and 22.

Such conventional double and single band log-periodic dipole antennae typically employ the dipole elements comprising wires, so that the space occupied by them becomes considerably large to transmit and receive data over a great distance. In order to resolve the problem of the large space requirement, there have been proposed the planar type antennae, which may be constructed by employing slots and micro-strip signal lines, coplanar waveguide, or varieties of the forms of the dipole elements. However, such antenna structures not only suffer distortion of their radiating patterns according to the broad-band characteristics, but also experience a decrease of the gain due to low radiating efficiency in a higher frequency region.

### SUMMARY OF THE INVENTION

The present invention to provides a broad-band log-periodic dipole antenna having a plurality of radiating elements arranged on a first and second parallel surface of a dielectric substrate, wherein the plurality radiating elements are supplied alternately with signals through a transmission line so as to produce high gain in a wide resonant frequency band and to prevent distortion of the radiating patterns according to the broad-band characteristics.

The present invention also provides a broad-band log-periodic dipole antenna that is designed to have a small size by arranging a plurality of radiating elements in both surfaces of a dielectric substrate having a first and second parallel surface, thus facilitating mass production with low cost.

According to an aspect of the present invention, a broad-band log-periodic dipole antenna comprises a dielectric substrate having a first and second parallel surface, at least one radiating element arranged in said first and second surface of the dielectric substrate according to the log-periodic ratio and the scaling constant including the dielectric constant of the dielectric substrate, and a transmission line provided in a center of the radiating element.

Preferably, the at least one radiating element further comprises at least a first radiating element made of a half of a pre-determined length alternately arranged in the first surface of the dielectric substrate with a given interval, and at least a second radiating element made of another half of the pre-determined length arranged in the second surface of the dielectric substrate symmetrically with respect to the first radiating element.

Preferably, the first and second radiating elements are arranged with different lengths and the given interval according to the log-periodic ratio and the scaling constant including the dielectric constant of the dielectric substrate.

### BRIEF DESCRIPTION OF THE DRAWINGS

The above and other features and advantages of the present invention will become more apparent from the following detailed description when taken in conjunction with the accompanying drawing in which:

FIG. 1A is a schematic diagram illustrating a structure and design parameters of a conventional single log-periodic dipole antenna;

FIG. 1B is a schematic diagram illustrating a structure of a conventional double band log-periodic dipole antenna;

FIG. 2 is a schematic diagram illustrating a structure of a broadband log-periodic dipole antenna according to the present invention;

FIG. 3 is a graph representing characteristics of a reflection coefficient of a broadband log-periodic dipole antenna according to the present invention; and

FIGS. 4A to 4D are graphs illustrating characteristics of the radiating patterns of a broadband log-periodic dipole antenna according to the present invention.

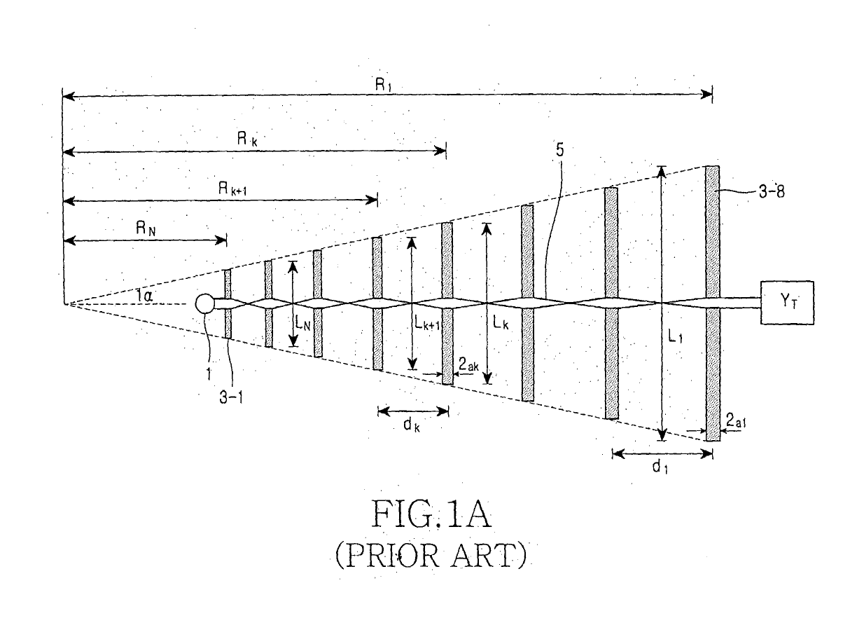

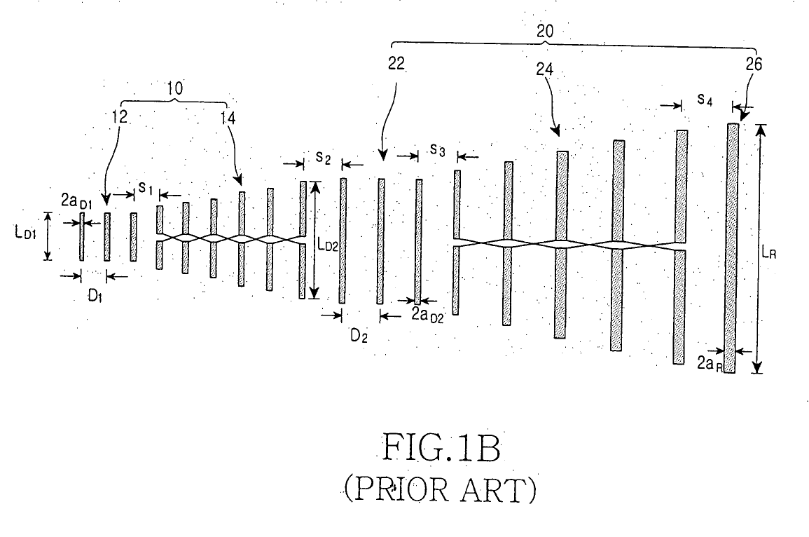

### DETAILED DESCRIPTION

Exemplary embodiments of the present invention are described hereinbelow with reference to the accompanying drawings. In the drawings, the same or similar elements are denoted by the same reference numerals even though they are depicted in different drawings. For the purposes of clarity and simplicity, well-known functions or constructions are not described in detail since they would obscure the invention in unnecessary detail.

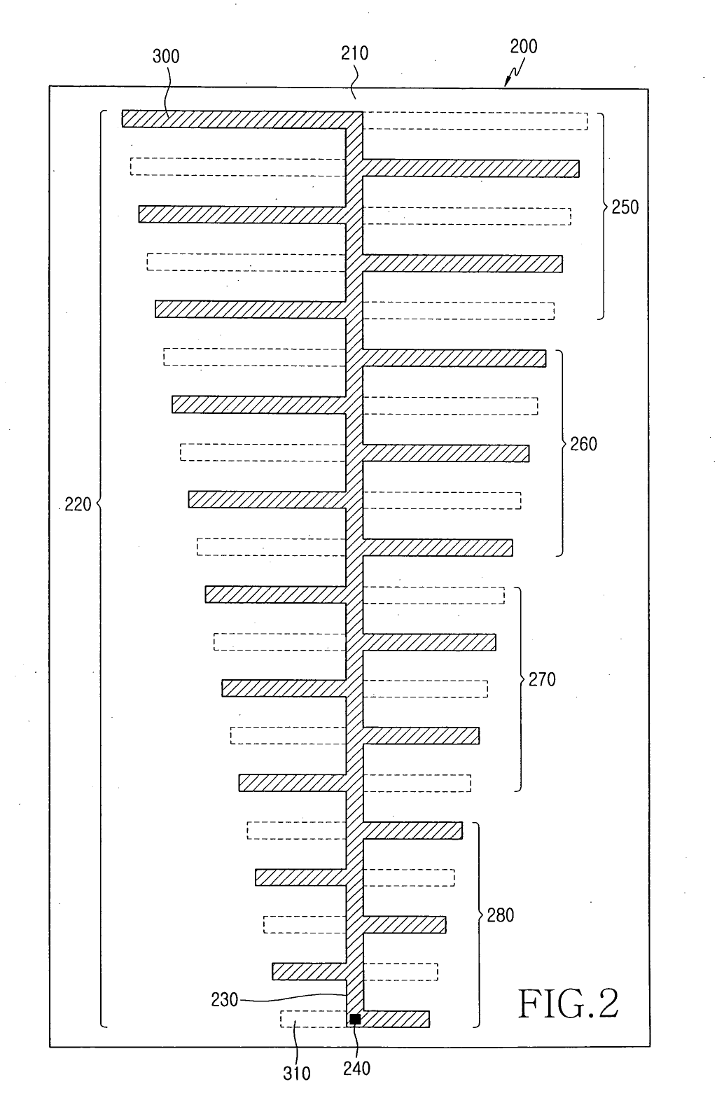

Referring now to FIG. 2, a first embodiment of a broadband log-periodic dipole antenna 200 is achieved by modifying the fundamental structure according to Carrel with introduction of the dielectric constant ε_{eff} of the dielectric substrate to the log-periodic ratio τ and the scaling constant σ as respectively defined by the general Formulas 1 and 2 so as to arrange the radiating elements with a given interval. Hence, the dipole antenna 200 is defined by the following Formula 3 with the dielectric constant ε_{eff} of the dielectric substrate applied to the length Lₖ of the dipole element and the interval dₖ between adjacent dipole elements contained in the Formulas 1 and 2:

$${d}_{k}^{′} = \frac{{d}_{k}}{\sqrt{{ɛ}_{eff}}} , {L}_{k}^{′} = \frac{{L}_{k}}{\sqrt{{ɛ}_{eff}}} \\ {d}_{k + 1}^{′} = \frac{{d}_{k + 1}}{\sqrt{{ɛ}_{eff}}} , {L}_{k + 1}^{′} = \frac{{L}_{k + 1}}{\sqrt{{ɛ}_{eff}}} \qquad Formula 3$$

Thus, applying Formula 3 containing the dielectric constant ε_{eff} of the dielectric substrate to the log-periodic ratio τ of the design parameter and the interval scaling constant a of Formulas 1 and 2, the lengths of the radiating elements and the interval between adjacent radiating elements are determined so as to fit the intended resonant frequency band. The determination of the resonant frequency band depends on the resonant frequencies of both the longest and the shortest element, and the dielectric substrate is made to have a low dielectric constant featuring low dielectric loss in order to increase the antenna gain.

The broadband log-periodic dipole antenna 200 comprises a dielectric substrate 210, at least one radiating element 220 arranged in each of a first and second parallel surface of the dielectric substrate 210 with a given interval, and a transmission line 230 provided in a center of the at least one radiating element 220. The dielectric substrate 210 comprises a planar circuit board having a dielectric constant ε_{eff} of 2.2 and a thickness of 1.57 mm.

Each at least one radiating element 220 is designed to have a length pattern corresponding to a half wavelength of a frequency band from PCS frequency band of 1.7 GHz to 1.9 GHz represented by reference numeral 250, to IMT-2000 frequency band of 1.9 GHz to 2.2 GHz by reference numeral 270, to wireless LAN frequency band (IEEE 802, 11a/b) of 2.2 GHz to 5.8 GHz by reference numeral 270, and a given interval, based on the log-periodic ratio τ and the interval scaling constant σ modified by Formula 3 according to the dielectric constant ε_{eff} of 2.2.

Each at least one radiating element 220 consists of a first plurality of radiating components 300 alternately arranged in the first surface of the dielectric substrate 210 with the given interval, said first plurality of radiating components 300 respectively corresponding to the half wavelengths of PCS frequency band 250, IMT-2000 frequency band 260, and wireless LAN frequency band (IEEE 802, 11a/b) 270 and 280, and second plurality of radiating components 310 alternately arranged in the second surface of the dielectric substrate 210 symmetrically with respect to the first plurality of radiating components, said second plurality of radiating components 310 respectively corresponding to the half wavelengths of PCS frequency band 250, IMT-2000 frequency band 260, and wireless LAN frequency band (IEEE 802, 11a/b) 270 and 280. Thus, the first and second radiating components 300 and 310 are respectively arranged in the first and second surface of the dielectric substrate 210 with a pattern of the different lengths belonging to the corresponding frequency bands of PCS 250, IMT-2000 260, and wireless LAN (IEEE 802, 11a/b) 270 and 280, thereby producing multiple resonant frequency bands 250 to 280.

The transmission line 230 is provided along the central axis of the pattern of the first and second plurality of radiation components of the at least one radiating element 220 arranged in the first and second surface of the dielectric substrate 210 having a signal feeding point 240 to supply signals to the transmission line 230. Both gain and standing wave characteristics of the antenna are improved with the length of the transmission line 230. Thus, the transmission line 230 supplies signals alternately to the first and second plurality of radiation components 300 and 310 alternately arranged in the first and second surface of the dielectric substrate 210 corresponding to the pattern of PCS frequency band 250, IMT-2000 frequency band 260, and wireless LAN (IEEE 802, 11a/b) frequency band 270 and 280 to make the impedance matching, so that the antenna 200 may obtain high gain in each of the resonant frequency bands 250 to 280 and prevent the distortion of the radiating patterns owing to the broadband characteristics.

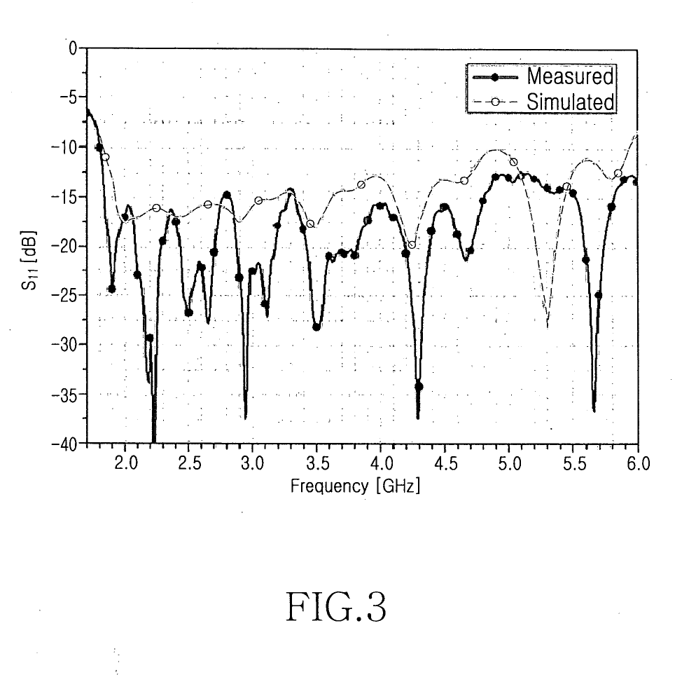

FIG. 3 illustrates the characteristics of the reflection coefficient (dB) of the embodiment of the broadband log-periodic dipole antenna 200. The dashed line with dots shows the calculated characteristics of the reflection coefficient over the broadband of 1.8 GHz to 6 GHz including the presently available PCS frequency band 250, IMT-2000 frequency band 260, and wireless LAN (IEEE 802, 11a/b) frequency band 270 and 280. The solid lines with dots shows the measured characteristics of the reflection coefficient designed according to the present invention.

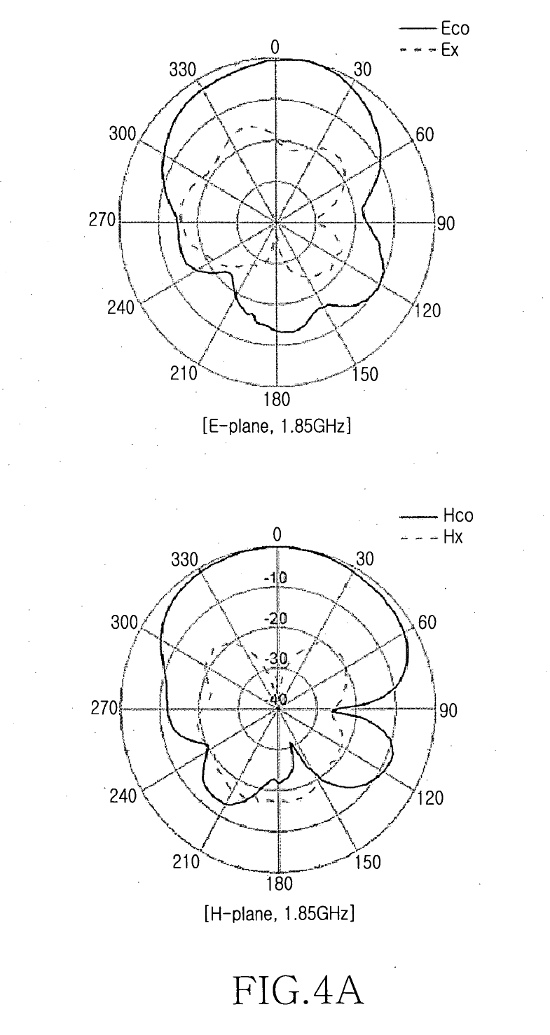

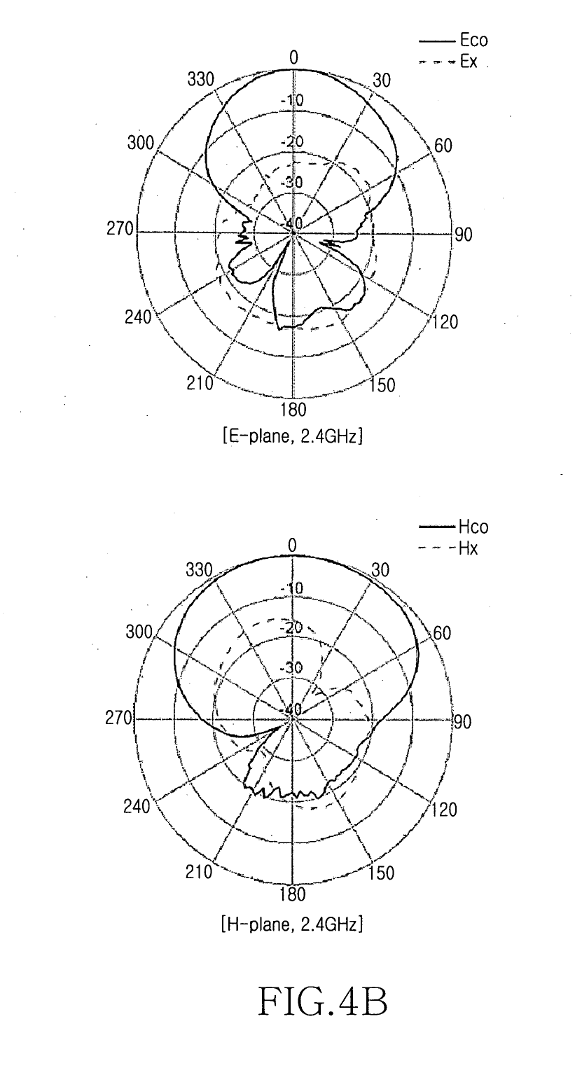

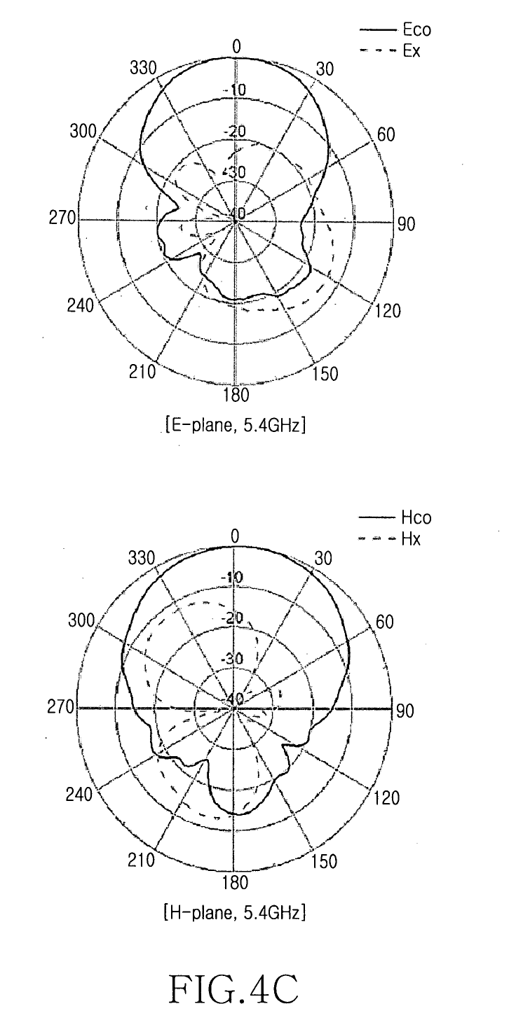

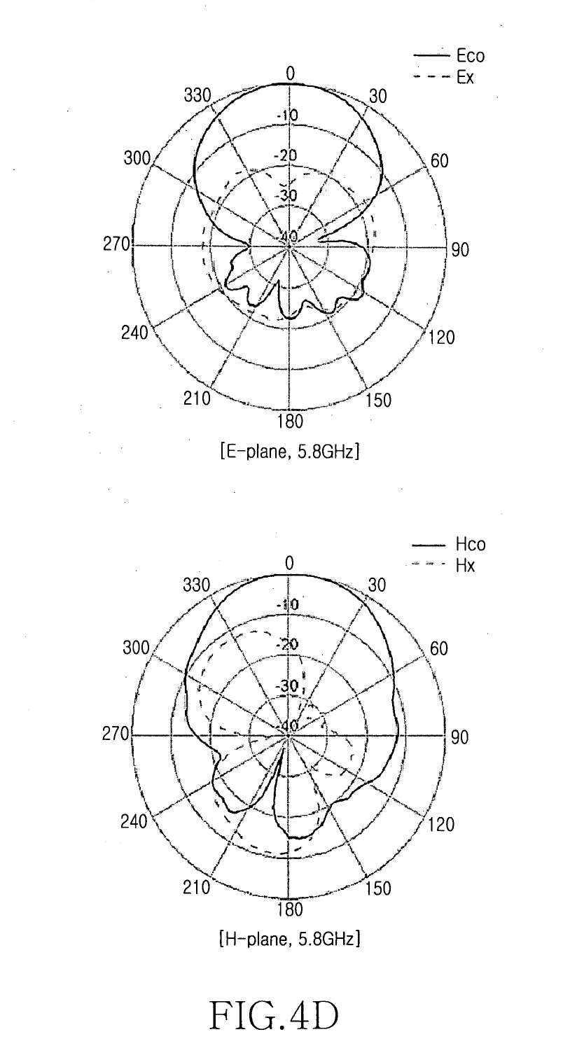

FIG. 4 illustrates the characteristics of the radiating patterns (dBi) of an embodiment of a broadband log-periodic dipole antenna 200, according to the present invention. FIGS. 4A to 4D correspond to the measured radiation patterns of E-plane and H-plane at 1.85 GHz, 2.4 GHz, 5.4 GHz, and 5.8 GHz, respectively. As illustrated in the drawing, the antenna 200 shows gains of 6 to 12 dBi in the frequency bands of 1.85 GHz, 2.4 GHz, 5.4 GHz, and 5.8 GHz including the presently available PCS frequency band 250, IMT-2000 frequency band 260, and wireless LAN (IEEE 802, 11a/b) frequency band 270 and 280.

Thus, the present invention provides a broadband log-periodic dipole antenna having first and second radiating components alternately and symmetrically arranged in parallel first and second surfaces of a dielectric substrate according to the corresponding PCS frequency band, IMT-2000 frequency band, and wireless LAN (IEEE 802, 11a/b) frequency band, so that the first and second radiating components are alternately supplied with signals to make the impedance matching, thereby producing high gain in each of the resonant frequency bands and preventing the distortion of the radiating patterns owing to the broadband characteristics. Furthermore, the arrangement of the first and second radiating components in parallel first and second surfaces of the dielectric substrate considerably reduces the size of the antenna, thereby facilitating mass production with low cost.

While the invention has been shown and described with reference to a certain preferred embodiment thereof, it will be understood by those skilled in the art that various changes in form and details may be made therein without departing from the spirit and scope of the invention as recited by the appended claims.

What is claimed is:

1. A broad-band log-periodic dipole antenna, comprising:
a dielectric substrate having a first and second parallel surface;
at least one radiating element arranged in said first and second surface of said dielectric substrate according to a log-periodic ratio τ and a scaling constant including a dielectric constant ε_{eff} of said dielectric substrate; and
a transmission line provided in a center of said at least one radiating element.

2. A broad-band log-periodic dipole antenna according to claim 1, wherein said at least one radiating element further comprises a first set of at least one first radiating component of a half of a pre-determined length alternately arranged as adjacent radiating components in one surface of said first and second surface of said dielectric substrate with a given interval, and a second set of at least one second radiating component of a half of the pre-determined length alternately arranged as adjacent radiating components in an other of said first and second surface of said dielectric substrate symmetrically with respect to said first set of at least one first radiating component.

3. A broad-band log-periodic dipole antenna according to claim 2, wherein each component of said first set and each component of said second set is arranged with different lengths Lₖ for k=1, 2, . . . , n−1 and the given interval according to the log-periodic ratio and the scaling constant including the dielectric constant of said dielectric substrate.

4. A broad-band log-periodic dipole antenna according to claim 3, wherein the log-periodic ratio τ is defined by the following formula,
$$τ = \frac{{L}_{k + 1}}{{L}_{k}} = \frac{{d}_{k + 1}}{{d}_{k}}$$
wherein k=1, 2, 3 . . . n−1, and a length Lₖ of a k^{th} radiating component of said first set and said second set and an interval dₖ, between adjacent radiating components respectively thereof, include the dielectric constant ε_{eff} of the dielectric substrate as defined by the following Formula 4:
$${d}_{k}^{′} = \frac{{d}_{k}}{\sqrt{{ɛ}_{eff}}} , {L}_{k}^{′} = \frac{{L}_{k}}{\sqrt{{ɛ}_{eff}}} \\ {d}_{k + 1}^{′} = \frac{{d}_{k + 1}}{\sqrt{{ɛ}_{eff}}} , {L}_{k + 1}^{′} = \frac{{L}_{k + 1}}{\sqrt{{ɛ}_{eff}}} \qquad Formula 4$$

5. A broad-band log-periodic dipole antenna according to claim 4, wherein the dielectric constant of the dielectric substrate is 2.2.

6. A broad-band log-periodic dipole antenna according to claim 2, wherein each radiating component of said first set and each radiating component of said second set has a different length and a corresponding interval dₖ between adjacent radiating components thereof so as to produce multiple resonant frequency bands.

7. A broad-band log-periodic dipole antenna according to claim 6, wherein said multiple resonant frequency bands are PCS band, IMT-2000 band, and wireless LAN band.

8. A broad-band log-periodic dipole antenna according to claim 1, wherein said transmission line is connected to the center of said at least one radiating element so as to supply signals thereto alternately.

9. A broad-band log-periodic dipole antenna according to claim 1, wherein said dielectric substrate comprises a planar circuit board having a given dielectric constant.

10. A broad-band log-periodic dipole antenna according to claim 1, wherein the at least one radiating element is supplied alternately with signals through said transmission line so as to make the impedance matching occur in multiple resonant frequency bands.

11. A broad-band log-periodic dipole antenna comprising:
a dielectric substrate;
a plurality of radiating elements arranged in said dielectric substrate according to a pre-determined log-periodic ratio and a pre-determined scaling constant including a dielectric constant of said dielectric substrate; and
a transmission line provided in a center of said plurality of radiating elements.

12. A broad-band log-periodic dipole antenna according to claim 11, wherein said plurality of radiating elements is arranged having different lengths corresponding to pre-determined intervals.
